(19) United States
(12) Patent Application Publication
(10) Pub. No.: US 2006/0103083 A1
(43) Pub. Date: May 18, 2006

(54) Automobile lowering methods and systems

(75) Inventor: Darryl Connors, Athens, GA (US)

Correspondence Address: TROUTMAN SANDERS LLP, 600 PEACHTREE STREET , NE, ATLANTA, GA, 30308, US

(73) Assignee: American Vans, Inc., Danielsville, GA (US)

(21) Appl. No.: 11/274,785

(22) Filed: Nov. 14, 2005

Related U.S. Application Data
(60) Provisional application No. 60/627,303, filed on Nov. 12, 2004.

(51) Int. Cl. B60G 17/00; B60P 3/34

(52) U.S. Cl. 280/6.157; 180/89.1; 296/26.04

(57) ABSTRACT

The many embodiments of the present invention disclose and teach methods and systems for lowering automobiles. Some embodiments of the present invention may be installed on and used with vans so that van consumer may have high-top vans that are garageable, parkable, and washable. An embodiment of the present invention may generally comprise a van roof with a specific predetermined height adapted to increase the interior volume of a van, a suspension system adapted to lower a van and enhance the performance capabilities of a van's suspension system, and a tire/wheel combination adapted to lower a van without affecting a van's operating instruments. The embodiments of the present invention may be used to provide a van with a high-top roof with a predetermined exterior height yielding a high-top van that is garageable, parkable, and washable. Other embodiments are also claimed and described.

### CROSS-REFERENCE TO RELATED APPLICATION

This patent application claims priority to and the benefit of U.S. Provisional Application No. 60/627,303, filed 12 Nov. 2004, which is incorporated herein by reference in its entirety as if fully set forth below.

### TECHNICAL FIELD

The various embodiments of the present invention relate generally to automobiles and other passenger vehicles, and more specifically, to methods and systems for lowering and retrofitting automobiles to maximize the internal volume (or space) of an automobile.

### BACKGROUND

Within the past two decades, the automobile industry has seen strong consumer demand for large vehicles. In response, automobile manufacturers have and are continuing to provide larger vehicles including sport utility vehicles, large luxury pick-up trucks, and large family-sized vans. Most automobile manufacturers continue to sell more of these large vehicles, all the while introducing new models of larger vehicles in efforts to satisfy consumer demand for larger vehicles.

Consumers are driven by many desires to purchase and use large vehicles. Many consumers purchase the large vehicles because they feel safer driving these vehicles rather than smaller vehicles. Large vehicles also have larger roomy interiors capable of holding multiple passengers, large amounts of cargo, and various entertainment sources.

Automobile manufacturers are not the only industry catering to consumer demand for larger vehicles. Aftermarket conversion companies respond to consumer demand by retrofitting large factory-built automobiles to make them larger, and to have custom designed and built interiors and exteriors.

While both automobile manufacturers and conversion companies continue to increase the interior spaces of vehicles, they are also enlarging the overall external size of vehicles. The ever-increasing external size of vehicles poses several problems including potential safety hazards to large vehicle owners. Generally, smaller-sized vehicles easily fit into structures designed and built to hold or contain automobiles. For example, most small cars encounter no problems when entering parking garages or passing under low-lying structures. Larger vehicles and some models of retrofitted vehicles, however, are so tall that their overall external size prevents the large vehicle owner from enjoying or using their large vehicles due to their large sizes. Conventional high-top vans generally have custom manufactured van tops that add eight to twelve inches of exterior height to a van. As such, most high-top vans do not fit in conventional garages. Indeed, some high-top vans are so tall that they do not fit into carports or carwashes.

Some conventional high-top vans are so tall that they may even pose safety risks when a high-top van owner attempts to park or drive under low-hanging structures or other low-hanging hazards such as automated carwashes. Additionally, some conventional high-top van owners must purchase specially designed covers or utilize RV parking because conventional high-top vans are too tall to fit in standard covered parking areas.

What is needed, therefore, is a system and method for meeting the consumer demand of increasing and maximizing the interior space of vehicles while at the same time providing a safe and hazard free automobile.

### BRIEF SUMMARY

The various embodiments of the present invention provide automobile lowering methods and systems enabling automobile owners to have both high-top roofs and a vehicle with an external size less than certain predetermined thresholds. The embodiments of the present invention can include a specially designed novel van top and a lowering system enabling van owners to have a high-top roof and utilize garages, parking areas, and car washes generally designed for small cars. Thus, the embodiments of the present invention can satisfy consumer demand in the industry for garageable, parkable, and washable high-top vans and other similar large-sized automobiles.

In an embodiment of the present invention, a system to provide an automobile having a height below a predetermined threshold can comprise a top, a suspension system, and a wheel system. The top can be coupled to and extend above the automobile to increase an interior volume within the automobile. The top can increase an internal height within the automobile in a range of about one inch to about eight inches thereby increasing the interior volume within the automobile.

The suspension system can be adapted to lower the automobile close to a driving surface such that the center of gravity of the automobile is moved closer to the driving surface. The suspension system can be coupled to the automobile. The wheel system can be adapted to lower the automobile close to the driving surface so that the wheel system does not affect the automobile's operating instruments. Preferably, the top, the suspension system, and the wheel system alter the height of the automobile so that the height falls below the predetermined threshold and the interior volume within the automobile is increased. The predetermined threshold can be approximately eighty-four inches so that the automobile can pass under structures having an entrance height of eighty-four inches.

The automobile can further comprise a plurality of doors, and the top can be adapted to fit or adhere to the automobile so that it does not interfere with any of the doors. This enables the doors to open and close according to their original design constraints so that the doors do not have to be altered to operate properly.

The suspension system can comprise a front wheel suspension system and a rear suspension system. The front wheel suspension system can have a coil spring, a bump stop, and one or more shocks. The coil spring can have a length of approximately fourteen to approximately fifteen inches. The bump stop can have a length of approximately two inches. The shock can have an internal pressure of approximately 150 pounds per square inch (PSI). The rear suspension system can have a leaf spring having a length of approximately 59.5 inches, and a shock having an internal pressure of approximately 150 pounds per square inch (PSI).

The wheel system can include a tire and wheel combination. The tire and wheel combination can have a combination height that is approximately five percent lower than a factory-standard wheel and tire combination associated with the automobile. In other words, the tire and wheel combination can be used to replace an original tire and wheel combination and it can have a total overall height that is reduced by approximately five percent relative to the original tire and wheel combination.

In another embodiment of the present invention, a method to alter an interior volume and a height of an automobile having a top, a suspension system, and a wheel system can first comprise determining a predetermined height threshold. Next, the method can include altering the top, the suspension system, and the wheel system so that the height of the automobile is decreased below the predetermined height threshold. Preferably, the predetermined height threshold is approximately eight-four inches so that the automobile can pass under structures having an entrance height of eighty-four inches. The automobile can be a van, a truck, or a sport-utility vehicle. The automobile can also be other types of automobiles.

According to the method, altering the top can comprise increasing an internal height within the automobile in a range of about one inch to about eight inches thereby increasing the interior volume within the automobile. Altering the top can comprise at least partially removing a first top installed on the automobile and replacing it with a second top. The second top can comprise a front section adapted to decrease drag friction associated with the second top; a center section housing structural materials to provide structural strength to the top, wherein at least a part of the center section is proximate the front section; and a side area defining one or more openings and proximate the center section, wherein the side area is recessed relative to the center section so that the center section is raised above the side area.

Further according to the method, altering the suspension system can comprise adjusting the suspension system so that the overall height of the automobile is reduced in a range of approximately one inch to approximately three inches. The suspension system can comprise a stop bump, a shock, a leaf spring, and a coil spring, each having a length. Altering the suspension system can further comprise decreasing the length of at least one of the stop bump, the shock, the leaf spring, and the coil spring. The wheel system can comprise a tire having a tire height, and altering the wheel system can comprise reducing the tire height by approximately five percent. The wheel system can also include reducing a wheel height by five percent to correspond to the reduction in height of the tire.

In still yet another embodiment of the present invention, an automobile lowering system to alter a factory-standard automobile having a height and an internal volume so that the height of the automobile falls below a predetermined threshold and the internal volume of the automobile is increased can comprise a top, a suspension system, and a wheel system. The top can increase an interior height within the automobile in a range of about one inch to about eight inches thereby increasing the internal volume. The suspension system can lower the factory-standard automobile closer to a driving surface in a range of about one inch to about three inches. The wheel system can retrofit a first tire and wheel combination with a second tire and wheel combination that does not adversely affect operating instruments of the automobile. Preferably, the top, the suspension system, and the wheel system reduce the overall height of the automobile below the predetermined threshold. Ideally, the predetermined threshold is approximately eighty-four inches so that the automobile can pass under structures having an entrance height of eighty-four inches.

According to the system, the top can comprise various sections. For example, the top can comprise a front section adapted to decrease drag friction associated with the custom top, and a center section housing strengthening materials to provide structural strength to the top. At least a part of the center section can be proximate the front section. The top can also comprise a side area defining one or more openings and proximate the center section. The side area can be recessed relative to the center section so that the center section is raised above the side area. The top can also comprise insulating and noise-dampening materials to insulate the interior of the automobile from exterior temperatures and exterior noises.

Further according to the system, the suspension and the wheel system can also comprise various components. For example, the suspension system can alter the center of gravity of the automobile by lowering the center of gravity closer to the driving surface. Lowering or moving the center of gravity of the automobile enables the automobile body to be lowered so that the automobile has a lower ground clearance and also creates a safer automobile. The wheel system can comprise a tire and wheel combination that is approximately five percent shorter in height than the factory standard tire and wheel. Preferably, the tire and wheel combination does not have a higher height reduction so that the operating controls of the automobile are not adversely affected by the change in circumference of the tire and wheel.

### BRIEF DESCRIPTION OF DRAWINGS

FIG. 1 illustrates a perspective view of a conventional conversion van with a conventional high-top roof.

FIG. 2 illustrates a perspective view of a conversion van utilizing a lowering system in accordance with a preferred embodiment of the present invention.

FIG. 3 illustrates a front view (FIG. 3A) and a rear view (FIG. 3B) of a van utilizing a lowering system in accordance with a preferred embodiment of the present invention.

FIG. 4 illustrates a perspective view of a high-top roof used in accordance with a preferred embodiment of the present invention.

FIG. 5 illustrates a side view of a high-top roof used in accordance with a preferred embodiment of the present invention.

FIG. 6 illustrates a cross-sectional view of a high-top used in accordance with a preferred embodiment of the present invention.

FIG. 7 illustrates a comparison of a conventional front automobile suspension system (FIG. 7A) and a retrofit front automobile suspension system (FIG. 7B) used in accordance with a preferred embodiment of the present invention.

FIG. 8 illustrates a comparison of a conventional rear automobile suspension system (FIG. 8A) and a retrofit rear automobile suspension system (FIG. 8B) used in accordance with a preferred embodiment of the present invention.

FIG. 9 illustrates a logic flow diagram depicting a method of lowering an automobile used in accordance with a preferred embodiment of the present invention.

### DETAILED DESCRIPTION OF PREFERRED EMBODIMENTS

The various embodiments of the present invention generally enable automobile manufacturers, conversion companies, and consumers to create large vehicles that can fit into and under structures designed for smaller automobiles. Some embodiments of the present invention further enable users to retrofit large vans, trucks, and sport utility vehicles with custom-designed high-top roofs that maximize interiors of these automobiles, suspension systems, and tire/wheel combinations to lower an automobile. Automobiles utilizing the various embodiments of the present invention may have increased interior space and have the ability to drive under and into low lying structures designed for smaller vehicles.

For ease of discussion throughout this application, the various embodiments of the present invention may be discussed with reference to vans, but those skilled in the art will appreciate that the various embodiments of the present invention may be used with many other automotive vehicles, including (but not limited to) cars, trucks, and sport utility vehicles.

Van manufacturers typically design and create new van body styles each model year. These models may range from small mini-vans to mid-size vans to full-size cargo vans. The external and internal dimensions vary between models and also between manufacturers. Factory-built vans equipped with factory-available options do not satisfy the desire for some van consumers, whether these consumers are private consumers or businesses. To satisfy the need for these consumers, automobile conversion companies can adapt or retrofit a factory-standard van into a van suited for their respective consumers.

Typical conversion van companies start with a factory-standard van and perform any number of changes or install any number of customer choice options on a factory-standard van. Such changes and options may include roof alterations, custom internal and external decorative schemes, custom internal floor plans, custom manufactured seats, and custom installed external and internal electronic accessories. While some conversion options affect the interior of a van, several also affect the overall external size (e.g., height, length, etc.) of a van.

Two of the biggest factors affecting overall external van height are the van's roof and van's suspension system. Many options are available for consumers wanting altered or custom styled van roofs that increase the height of a van. These options may include high-top roofs, pop-up camper roofs, and RV-style roofs with an above cab sleeping area. These different roof options, while having different functions serve one purpose, to increase the overall interior size of a van.

These roof styles, however, also increase the overall height of a van from its factory-standard size. In many instances, the altered vans are so tall that they are not garageable, parkable, or washable in standard sized garages, parking decks, or carwashes.

Another important factor affecting the overall external height of a van is a van's suspension system. Typical factory-installed suspension systems are not designed for decreasing a van's external height. Instead, factory suspension systems are generally designed with safety and driving characteristics in mind. Factory-designed suspension systems may increase a van's external height up to twelve inches providing undesirable results to some consumers who desire high-top roofs. By redesigning these factors with a van's external height in mind, the inventor has discovered methods and systems for improving vans equipped with conventional high-top roofs.

FIG. 1 illustrates a perspective view of a conventional conversion van 100 equipped with a conventional high-top roof 105 having a height H_{ROOF}. Van 100 is also equipped with factory-standard front and rear suspension systems 110, 115, and also factory-standard tire/wheel combinations 120a, 120b, 120c. Van 100 has an overall external height H_{VAN}, which as depicted is greater than entrance height, H_{GARAGE}, for garage 150. H_{VAN} includes the height of the roof, H_{ROOF}, and the increased height due to suspension systems 110, 115 depicted by 125a, 125b and H_{CLEARANCE}. Since H_{VAN} is greater than H_{GARAGE}, van 100 can not enter into garage 150 and thus, the driver of van 100 is restricted from using garage 150. If the driver of van 100 attempted to enter garage 150 or forgot about the van's 100 total external height, and attempted to enter garage 150, a collision would occur. During the collision, the garage 150 may shear off a portion of conventional high-top roof 105 damaging the van 100 or garage 150. Also, the collision may potentially injure the van driver or others surrounding the van 100. This scenario depicts the frustration that many van consumers face when attempting to utilize garages, parking decks, or carwashes having entrance heights less than their vans equipped with a high-top roof. This scenario also depicts the potential safety hazards encountered by drivers of vans with conventional high-top roofs and low hanging structures.

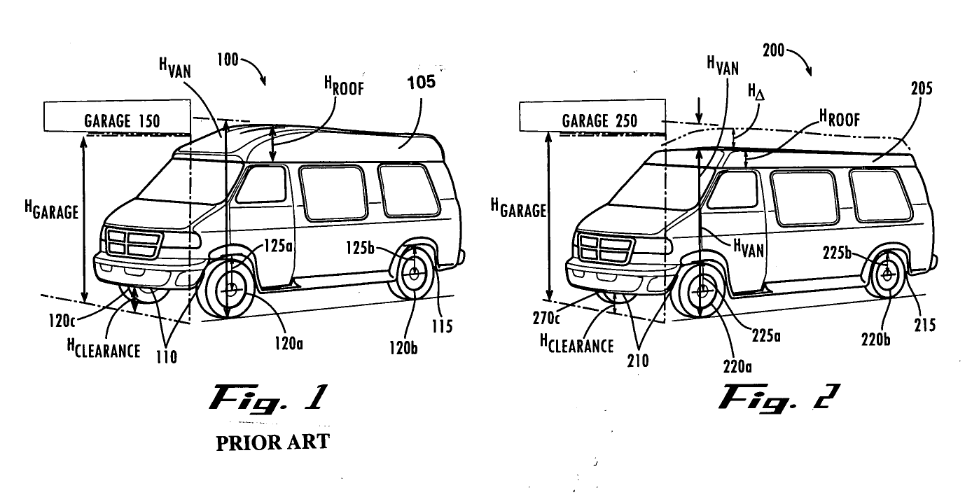

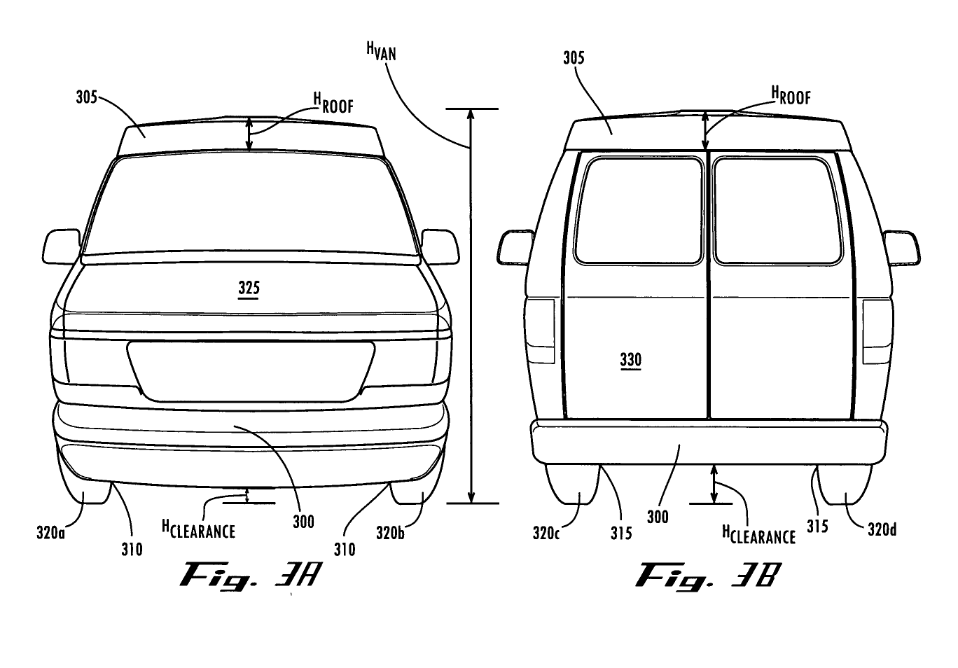

The various embodiments of the present invention provide systems and methods to produce vans equipped with high-top roofs that are garageable, parkable, and washable (“GPW”) in standard sized garages, parking decks, or carwashes. FIG. 2 illustrates a perspective view of a van 200 utilizing a preferred embodiment of the present invention. Van 200 is shown equipped with a lowering system of the present invention. Generally, the lowering system can include a high-top roof 205, front and rear suspension systems 210, 215, and tire/wheel combination 220a, 220b, 220c. These features of the present invention provide a van having the ability to have an external height, H_{VAN}, below a predetermined height threshold. In some embodiments, this height threshold may be approximately eighty-four (84) inches so that a conversion van or other automobile is GPW in standard-sized facilities. The eighty-four (84) inch threshold may be selected because eighty-four (84) inches is a standard height for most garages, parking decks, and carwashes. In some embodiments, however, it is also be possible to lower a van or other vehicle below other predetermined height thresholds. In yet other embodiments, a van or automobile may be lowered below a certain predetermined height using one or more of high-top roof 205, front and rear suspension systems 210, 215, and tire/wheel combos 220a, 220b, 220c.

As discussed in more detail below, the high-top roof 205 can be a custom-designed-high-top roof that increases the height of the van 200 and the headroom or interior space within the van 200, but also yields a van that is GPW. Also, the suspension systems 210, 215 and tire/wheel combinations 220 can be custom designed to lower the overall height of van 200 so that the increase in height of van 200 due to high-top roof 205 does not produce a van height that surpasses the predetermined height threshold.

As illustrated in FIG. 2, H_{VAN} is less than H_{GARAGE} and van 200 may enter garage 250. Also illustrated in FIG. 2 is the difference in height, H_{Δ}, resulting from utilization of an embodiment of the present lowering system. H_{Δ} can vary according to the implementation of the embodiments of the present invention. Van 200 can also be lowered by suspension systems 210, 215 to provide a lower ground clearance, H_{CLEARANCE}, and a smaller distance depicted as 225a, 225b between the tire wells of van 200 and the center point of the tire/wheel combinations.

FIG. 3 illustrates a front view (FIG. 3A) and a rear view (FIG. 3B) of a van utilizing a lowering system in accordance with a preferred embodiment of the present invention. Van 300 is equipped a high-top roof 305, front suspension system 310, rear suspension system 315, and tire/wheel combinations 320a, 320b, 320c, 320d. Van 300 has height H_{VAN} which includes H_{ROOF} and H_{CLEARANCE}. H_{VAN} can be predetermined in some embodiments, so that the high-top roof 305, front suspension system 310, rear suspension system 315, and tire/wheel combinations 320a, 320b, 320c, 320d can be configured so that H_{VAN} is less than the predetermined height. In some embodiments, van front 325 and van rear 330 may have different clearance heights, H_{CLEARANCE}, through configuration of front suspension system 310, rear suspension system 315, and tire/wheel combinations 320a, 320b, 320c, 320d. FIGS. 3A and 3B also illustrate that the high-top roof 305 can be configured so that when installed onto the van 300, the high-top roof 305 does not interfere with or cause any of the doors on the van 300 to operate differently from factory-standard conditions.

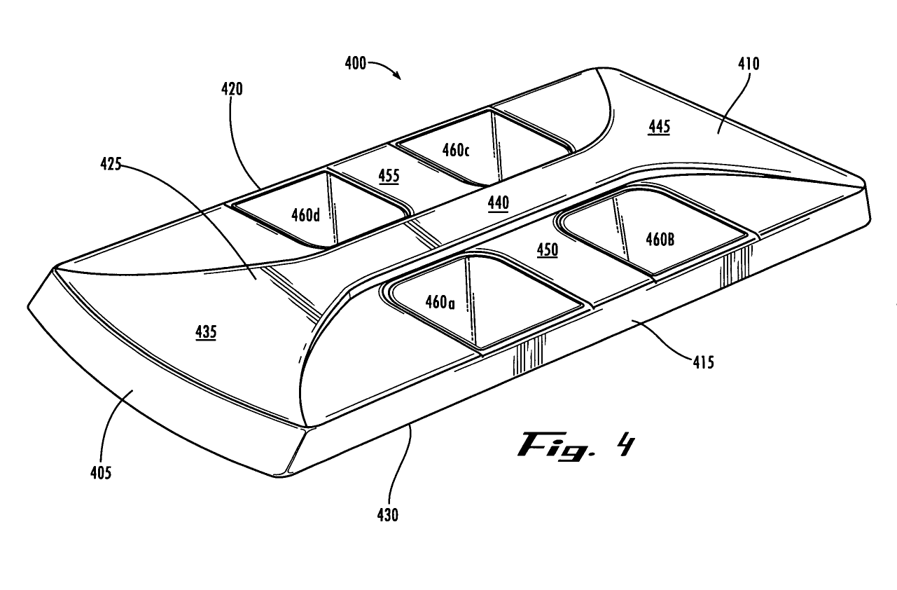

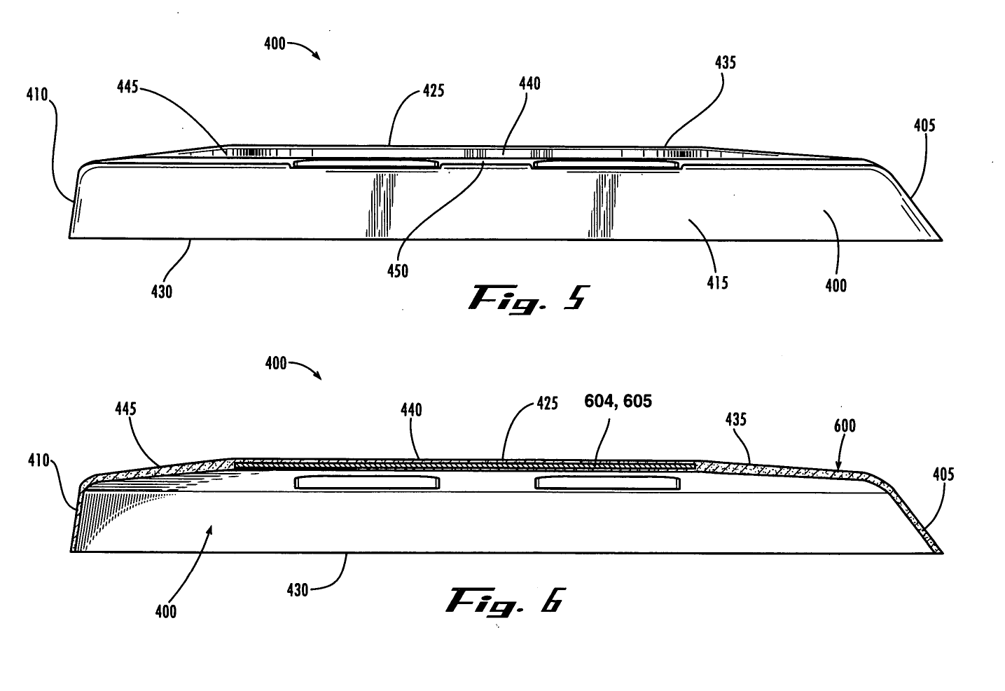

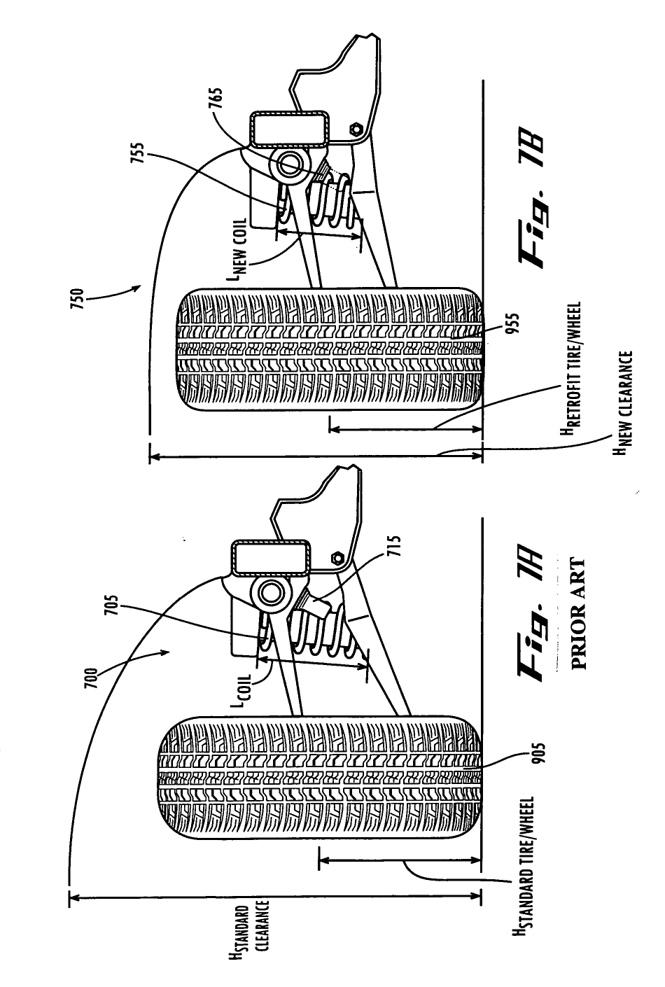

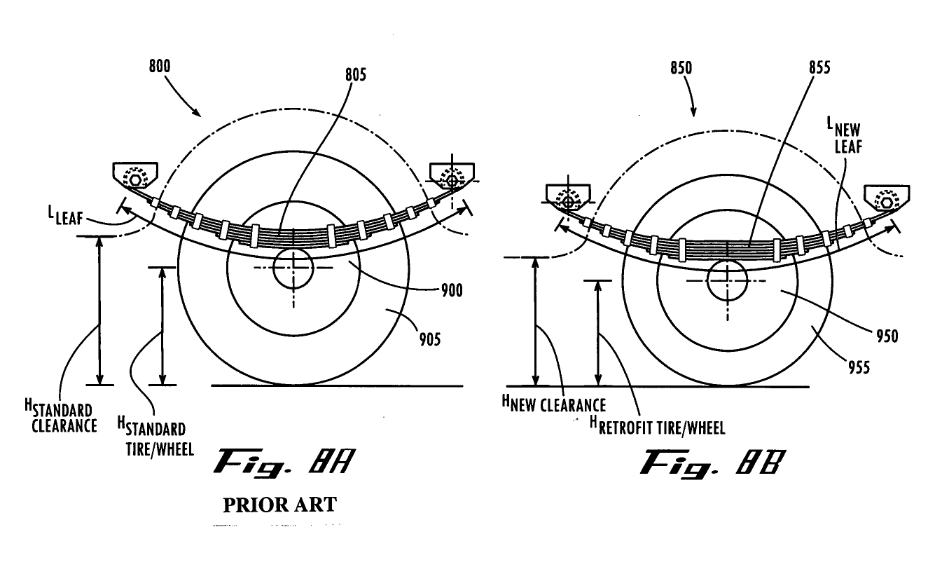

FIG. 4-6 illustrate a high-top roof 400 according to a preferred embodiment of the present invention. FIG. 4 illustrates a perspective view of the high-top roof 400. As shown, the high-top roof 400 includes front 405, rear 410, sides 415 and 420, top 425, and bottom 430. When installed onto a van, front 405 aligns with the front of a van, rear 410 aligns with the rear of a van, sides 415, 420 align with the sides of a van, and bottom 430 can be secured to the top of a factory-standard van. Equipping a factory-standard van with a high-top roof according to present invention may increase the headroom in a van by approximately one inch to approximately eight inches. The actual increase in headroom may depend on various factors such as van make and model. In addition, the increased headroom may also vary according to the materials applied to the underside of top 400, and may or may not be constant throughout the length of top 400.

The high-top roof 400 can have different configurations, appearances, and shapes. For example, front 405 can be curved or rounded in some embodiments to align with the curvature of a van front, mimic the external design of a van body, or for aerodynamic purposes. Likewise, rear 410 and sides 415, 420 can also be curved or rounded. Also, the overall shape of high-top roof 400 can be aerodynamically formed so that when high-top roof 400 is installed onto a van, the high-top roof 400 does not drastically increase a van's drag friction. For example, the high-top roof 400 can have a dome shape or may be slanted so that the height of the rear 410 is greater than the height of the front 405. In some embodiments, the high-top roof 400 can also be shaped so that it appears similar to the overall exterior design of a van.

High-top roof 400 can also include a front section 435, center section 440, rear section 445, and side areas 450, 455. Side areas 450, 455 can define a plurality of window or sunroof openings for windows 460a-d. High-top roof 400 can also have no window openings, differently shaped window openings, or windows placed in different arrangements in other embodiments. Also, side areas 450, 455 can be recessed relative to front section 435, center section 440, rear section 445 such that these sections are raised above the side areas 450, 455. The shape and depth of the recessed side areas 450, 455 can vary in different high-top roof embodiments. The recessing of side areas 450, 455 can provide structural strength or a high-top roof with less drag friction. For example, side areas 450, 455 can be semi-circular shaped as shown in FIG. 4. Additionally, side areas 450, 455 may not be recessed for increased van interior space or high-top roof 400 can have more recessed portions located in different van top areas in some embodiments of the present invention. Front section 435 and rear section 445 can also fan out when approaching the front 405 and rear 410 of high-top roof 400 such that the center section has a smaller cross sectional area than front section 435 and rear section 445.

FIG. 5 illustrates a side view of the high-top roof 400 in accordance with a preferred embodiment of the present invention. As illustrated, front section 435, center section 440, rear section 445 are elevated and raised above side areas 450, 455. In some embodiments, the amount of elevation over side areas 450, 455 may be constant while in others, the elevation amount may vary. For example, the elevation at the center section 440 may be greater than the front section 435 and rear section 445 thus providing a downwardly-curved-high-top roof 400. Also, front 405 may be slanted or curved to mimic the exterior design of a van or to decrease the overall drag of high-top roof 400. Likewise, rear 410, front section 435, center section 440, and rear section 445 may also be shaped to mimic the exterior design of a van or to decrease the overall drag of high-top roof 400. The front section 435, center section 440, and rear section 445, may also be designed to ensure that the high-top roof 400 has a certain predetermined structural strength. The top 400 may also be designed and adapted to divert rain water or other precipitate away from the front, rear, and sides of a van.

FIG. 6 illustrates a cross-sectional view 600 of the high-top roof 400 in accordance with a preferred embodiment of the present invention. The cross-sectional view 600 illustrates features which can be utilized to provide structural strength for high-top roof 400. The cross-sectional view 600 of high-top roof 400 depicts a lengthwise cross section of high-top roof 400 taken approximately near the center of high-top roof 400. High top-roof 400 has front 405, rear 410, front section 435, center section 440, and rear section 445. Center section 440 can include strengthening materials such as steel bands 604 or corrugated cardboard 605 in some embodiments. One or both of the steel bands 604 and corrugated cardboard 605 can be used to provide structural strength to high-top roof 400. Corrugated cardboard 605 can have a honeycomb-type shape or any other desirable shape capable or supplying structural strength to high-top roof 400. Other rigid lightweight structural strengthening materials such as plastic and carbon composites can also be used in place of or in addition to these materials to increase the structural strength of high-top roof 400.

The strengthening materials can be placed within the high-top roof 400 during fabrication or installed into the high-top roof after fabrication in a variety of arrangements. For example, steel bands 604 or corrugated cardboard 605 may be placed within high-top roof 400. In some embodiments, the steel bands 604 and cardboard 605 can be positioned to provide structural support for the entire high-top roof 400 while in other embodiments only certain predetermined portions may be reinforced with the steel bands 604 and cardboard. For example, the steel bands 604 and the corrugated cardboard 605 may be placed to run from the front section 435 through the center section 440 to the rear section 445. The structural strengthening materials can, however, also be placed in a variety of orientations, patterns, or combinations to reinforce high-top roof 400. For example, the structural strengthening materials may be placed in parallel or perpendicular to the face of a van or in any angle between such orientations.

The high-top roof 400 can also include insulating or noise-dampening materials. Insulating materials may provide an interior environment insulated from the exterior surrounding temperatures while noise-dampening materials can dampen exterior noises. The insulating materials and noise-dampening materials can be placed within the high-top roof 400, placed along the interior or underside of the high-top roof 400 to provide an insulated barrier between the interior of a van and the surrounding exterior environment, fabricated into the high-top roof 400. In some embodiments, the insulating and noise-dampening materials can be same materials while in other embodiments they may be different materials.

The high-top roof 400 can be formed with varying dimensions. The inventor has found that a length of approximately 146¼ inches, a width of approximately 56 3/16 inches, and a height of approximately 7⅝ inches provides a high-top roof adapted to fit some standard mid-range vans. Other dimensions, however, are also possible in other embodiments of the present invention. For example, the exact dimensions can be modified according to the predetermined height or the vehicle make and model. In some embodiments, however, the dimensions of the high-top roof 400 may be modified by the end user to fit various vehicle types. For example, an end user may be able remove the high-top roof 400 from one vehicle and install it on another vehicle.

The high-top roof 400 can be formed with various materials. For example, high-top roof 400 may be constructed with fiberglass using spray mold techniques so that any structural strengthening, insulating, or noise dampening materials may be placed within high-top roof 400 or built into high-top roof 400. Also, high-top roof 400 is preferably made with lightweight sturdy materials to provide a study van roof. For example, high-top roof 400 may be constructed with fiberglass using spray mold techniques so that any structural strengthening, insulating, or noise dampening materials may be placed within high-top roof 400. Other materials may also be used to construct high-top roof 400 including various plastics or other lightweight rigid materials.

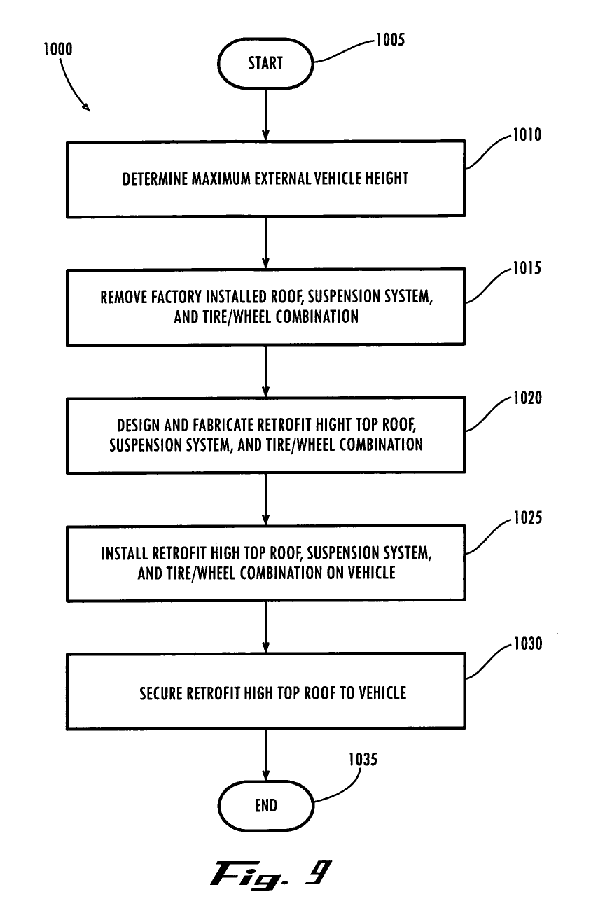

FIG. 7 illustrates a comparison of a conventional front automobile suspension system 700 (FIG. 7A) and a retrofit front automobile suspension system 750 (FIG. 7B) used in accordance with a preferred embodiment of the present invention. For discussion purposes, only one front suspension system is shown, and those skilled in the art will understand that the following discussion applies to front right and front left suspension systems. The inventor has discovered that using suspension system 750 to retrofit a factory-standard suspension system will achieve approximately a one to three inch drop to lower the overall external height of a van. The inventor has also discovered that suspension system 750 can also improve the factory-standard suspension system 700 by producing a lower center of gravity for a van. In some embodiments, it may not be necessary to alter all of the individual components of the conventional front automobile suspension system 700.

The conventional suspension system 700 includes a coil spring 705, a shock (not shown), and a bump stop 715. Coil spring 705 has length L_{COIL}, the well housing the suspension system 700 has factory-standard ground clearance height, H_{STANDARD CLEARANCE}, and the bump stop 715 is a factory-standard bump stop. The retrofit suspension system 750 can comprise a coil spring 755, a shock (not shown), and a trimmed bump stop 765. Coil spring 755 may have length L_{NEW COIL}, the van body well housing the suspension system 750 may have ground clearance height, H_{NEW CLEARANCE}, and the bump stop 765 which may be a trimmed bump stop. Coil spring 755 is preferably shorter than factory-standard coil spring 705 and can also have an increased stiffness relative to factory-standard coil spring 705. For example, coil spring 755 can have a length ranging from approximately fourteen (14) to fifteen (15) inches. The coil spring 755 can have a spring (or stiffness) factor greater than the factory-standard coil spring. Although coil spring 755 may have other physical characteristics, the inventor has found that these characteristics achieve the overall goal of lowering a van without sacrificing a van's operating characteristics.

The retrofit shocks forming part of retrofit suspension system 750 can be shorter than factory-standard shocks and can also be high pressure nitrogen gas charged shocks. For example, the retrofit shocks can have a length that is approximately five (5) percent less than factory-standard shocks. In addition, the retrofit shocks may have greater internal pressure than factory-standard shocks, such as approximately 150 pounds per square inch (PSI). Other shocks can also be used in accordance with the many embodiments of the present invention, and in some embodiments, the factory-standard shocks can be utilized.

In addition to replacing factory-standard coil spring 705 and shocks, the inventor has discovered that altering the factory-standard bump stop 715 also assists in lowering a van. For example, removing a lower section of approximately one inch from the factory-standard bump stop 715 yields a bump stop 765 adapted to function with retrofit coil springs 755 and retrofit shocks. As illustrated in FIG. 7B, the removed portion, shown in hatched lines, yields a smaller bump stop 765. The bump stop 765 can have a length of approximately two inches. Other embodiments of the present invention may utilize shorter bump stops in implementing the many embodiments of the present invention.

FIG. 8 illustrates a comparison of a conventional rear automobile suspension system 800 (FIG. 8A) and a retrofit rear automobile suspension system 850 (FIG. 8B) used in accordance with a preferred embodiment of the present invention. Conventional rear automobile suspension system 800 includes a factory-standard leaf spring 805, shock (not shown), and bump stop. The factory-standard leaf spring 805 has length, L_{LEAF}. A van utilizing a conventional rear automobile suspension system 800 has ground clearance H_{STANDARD CLEARANCE}. Retrofit rear automobile suspension system 850 may include a leaf spring 805, shock (not shown), and stop bump (not shown, but can have a length of approximately four inches). Leaf spring 805 has length, L_{NEW LEAF}, and the van utilizing retrofit rear automobile suspension system 850 has ground clearance H_{NEW CLEARANCE}. In some embodiments of the present invention, one or more of these components may be altered but in some embodiments, it may not be necessary to alter of a rear automobile suspension system's 800 components.

The inventor has discovered that using retrofit rear automobile suspension system 850 can achieve approximately a one to three inch drop in lowering a van's overall external height. The inventor has also discovered that rear automobile suspension system 850 can improve the factory-standard suspension system and produce a lower center of gravity for a van, thus providing a safer van. Leaf spring 855 may be shorter than factory-standard leaf spring 805 and may also have an increased stiffness relative to factory-standard leaf spring 805. For example, leaf spring 855 may have a length that is approximately one (1) percent shorter than the factory-standard leaf spring 805. In addition, leaf spring 855 can be approximately fifteen (15) percent stiffer than the factory-standard leaf spring 805. The leaf spring 855 can have a length that ranges from approximately 58 to approximately 60 inches, and may have a length of approximately 59.5 inches, which can be longer than the factory standard leaf spring 805. Although leaf spring 855 may have other physical characteristics, the inventor has found that these characteristics achieve the overall goal of lowering a van without sacrificing a van's operating characteristics.

Rear shocks can also be included as a component of rear suspension system 850. These shocks can be shorter than those utilized in suspension system 800, and can be high pressure nitrogen gas charged shocks. For example, the retrofit rear shocks can be fifteen (15) percent shorter than the factory-standard shocks and have an internal pressure of approximately 150 pounds per square inch (PSI). Other shocks having other lengths can also be used, and in some embodiments, the factory-standard shocks may not be replaced with retrofit shocks. In addition to replacing the factory-standard coil springs and shocks, the inventor has discovered that altering the factory-standard rear bump stops also assists in lowering a van. For example, removing a lower section of approximately two and three-quarter inches from the factory-standard rear bump stop yields a bump stop adapted to function with suspension system 850. Other sized sections can also be removed from the factory-standard bump stops, or shorter bump stops can be used in other embodiments.

FIGS. 7 and 8 also illustrate a comparison of a factory-standard tire/wheel combination 900, 905 and a retrofit tire/wheel combination 950, 955 used in accordance with a preferred embodiment of the present invention. In FIG. 8, wheel 900 and tire 905 are a factory-standard tire/wheel combination having height, H_{STANDARD TIRE/WHEEL}, as measured from the ground to the wheel 900 center point. Conversely, wheel 950 and tire 955 are a custom tire/wheel combination having height, H_{RETROFIT TIRE/WHEEL}, as measured from the ground to the wheel 950 center point. The inventor has discovered that using a retrofit tire/wheel combination having an approximately five percent lower height than a standard tire/wheel combination will also assist in lowering a van's external height (i.e., H_{RETROFIT TIRE/WHEEL}=0.95*H_{STANDARD TIRE/WHEEL}). This lowering effect is illustrated in FIGS. 8 and 9, which show that H_{RETROFIT TIRE/WHEEL} is less than H_{STANDARD TIRE/WHEEL}. The inventor has also discovered that any greater height reduction (i.e., greater than approximately five percent) may cause a van's operating instruments to produce erroneous results because speedometers, mileage gauges, and tachometers have predetermined calibrated tolerance ranges dependent upon factory-standard tire/wheel characteristics.

FIG. 10 is a logic flow diagram depicting a method 1000 of lowering an automobile and increasing the interior volume of an automobile used in a preferred embodiment of the present invention. A first step in method 1000 at 1005 is to determine a maximum external height for an automobile. Such a determination may provide the basis for designing and implementing a lowering system and method. For example, selecting a maximum external height of approximately eighty-four (84) inches for a van can assist in determining the degree in which the height of the van may be modified. Next at 1010, the factory-standard top, suspension, and tire/wheel combination installed on a van are removed. The factory-standard top can be removed with conventional removal techniques including metal cutting techniques. In some embodiments, most of the factory-standard top may be removed so that only a small rim of the factory-standard top remains intact. Typically, however, only the portion of the top located behind the front seat is removed for safety reasons. At 1015, a custom high-top roof and custom suspension are designed and fabricated to ensure that when installed onto a van, the van's external height is less than the predetermined maximum external height. Also during fabrication, the custom high-top roof may be equipped with structural strengthening, insulating, and noise dampening materials. In addition, a custom new tire/wheel combination can be utilized to assist in lowering an automobile. The custom high-top roof can also be manufactured to increase the interior volume of a van and may also be manufactured with fiberglass in various shapes and designs.

After the custom designed high-top roof and suspension are designed, they can be installed onto a van that has had its factory-standard top and suspension removed at 1020. The custom high-top roof can be placed onto a small rim made when removing the factory-standard top and adhered to the van body with a waterproof sealant adapted to bond the custom top to the van body. Different bonding adhesives may be used depending on the type material that the high-top roof is constructed from. The custom high-top roof may also be bolted or otherwise secured to the van body to ensure that the high-top roof is tightly secured to the van body. The custom suspension system may replace or retrofit the factory-standard system, and it may comprise a shorter stiffer coil spring and leaf spring. Additionally, the custom suspension system may comprise shorter bump stops than the factory-standard bump stops. Method 1000 can result in lowering an automobile closer to a driving surface such that the ground clearance of the automobile is approximately 7.25 inches at the lowest point of the automobile. Method 1000 is only a sample method embodiment of the present invention and other methods are also possible in accordance with the present invention.

As discussed above, the embodiments of the present invention can be used to lower an automobile's center of gravity when used to lower an automobile closer to a driving surface. In some embodiments of the present invention, automobiles can be lowered closer to a driving surface such that the automobiles have a ground clearance of approximately 7.25 inches at the lowest point of the automobile. In other embodiments other ground clearance levels are also achievable. This lowered ground clearance can thus affect and also lower the center of gravity for an automobile according to the embodiments of the present invention. For example, the inventor has discovered that the center of gravity for a General Motors Model G van is approximately 64.5 inches rearward from its front axle and approximately 33 inches from a flat driving surface. The inventor has also discovered that the center of gravity for a Ford Model E 150 van is approximately 65.8 inches rear of its front axle center line and approximately 33.5 inches from a flat driving surface. Indeed, embodiments of the present inventions have lowered the center of gravity for the General Motors Model G van by approximately 15 inches lower relative to its original manufacturing specifications, and lowered the center of gravity for the Ford Model E 150 van by about 2.5 inches relative to its original manufacturing specifications. Thus, the embodiments of the present invention can also be used to lower the center of gravity for an automobile thereby creating a safer driving automobile.

In still yet other embodiments of the present invention, the present invention can be a kit of materials used to retrofit an existing automobile to increase interior space within the automobile and lower the automobile so that its height is below a certain threshold. Indeed, a kit embodiment according the present invention can include a top, a suspension system, and a wheel system. The top can replace an existing automobile top and be coupled to and extending above the automobile to increase an interior volume within the automobile. The suspension system can replace or retrofit an existing automobile suspension system, and can be adapted to lower the automobile close to a driving surface such that the center of gravity of the automobile is close to the driving surface. The wheel system can be used to retrofit an existing wheel system and be adapted to lower the automobile close to the driving surface. In addition, the wheel system can be designed with inventive size and design constraints so that the wheel system does not affect the automobile's operating instruments. As with the numerous other embodiments of the present invention, the many kit embodiments which can include a top, a suspension system, and a wheel system can alter the height of the automobile so that the height falls below the predetermined threshold.

While the various aspects of the present invention have been discussed with reference to the above exemplary embodiments, the exemplary embodiments are not to be construed in any way as imposing limitations upon the scope of the claims of any patent issuing from this application. On the contrary, it is to be clearly understood that resort may be had to various other embodiments, modifications, and equivalents thereof which, after reading the description herein, may suggest themselves to those skilled in the art without departing from the spirit of the present invention and/or the scope of the numerous embodiments of the present invention.

What is claimed is:

1. A system to provide an automobile having a height below a predetermined threshold, the system comprising:
a top coupled to and extending above the automobile to increase an interior volume within the automobile;
a suspension system adapted to lower the automobile close to a driving surface such that the center of gravity of the automobile is moved closer to the driving surface, the suspension system being coupled to the automobile;
a wheel system adapted to lower the automobile close to the driving surface, wherein the wheel system does not affect the automobile's operating instruments; and
wherein the top, the suspension system, and the wheel system alter the height of the automobile so that the height falls below the predetermined threshold.

2. The system of claim 1, wherein the predetermined threshold is approximately eighty-four inches so that the automobile can pass under structures having an entrance height of eighty-four inches.

3. The system of claim 1, further comprising a plurality of doors, wherein the top is adapted to not interfere with any of the doors.

4. The system of claim 1, the suspension system comprising a front wheel suspension system having: a coil spring with a length of approximately fourteen to approximately fifteen inches; a bump stop having a length of approximately two inches; and a shock having an internal pressure of approximately 150 pounds per square inch (PSI).

5. The system of claim 1, wherein the suspension system comprises a rear wheel suspension system having: a leaf spring having a length of approximately 59.5 inches; and a shock having an internal pressure of approximately 150 pounds per square inch (PSI).

6. The system of claim 1, wherein the wheel system includes a wheel and tire combination having a combination height that is approximately five percent lower than a factory-standard wheel and tire combination associated with the automobile.

7. The system of claim 1, wherein the top increases an internal height within the automobile in a range of about one inch to about eight inches thereby increasing the interior volume within the automobile.

8. A method to alter an interior volume and a height of an automobile having a top, a suspension system, and a wheel system, the method comprising:
determining a predetermined height threshold;
altering the top, the suspension system, and the wheel system so that the height of the automobile is decreased below the predetermined height threshold; and
wherein the predetermined height threshold is approximately eight-four inches so that the automobile can pass under structures having an entrance height of eighty-four inches.

9. The method of claim 8, wherein the automobile is selected from the group comprising a van, a truck, and a sport-utility vehicle.

10. The method of claim 8, wherein altering the top comprises increasing an internal height within the automobile in a range of about one inch to about eight inches thereby increasing the interior volume within the automobile.

11. The method of claim 8, wherein altering the top comprises at least partially removing a first top installed on the automobile and replacing it with a second top, wherein the second top comprises:
a front section adapted to decrease drag friction associated with the second top;
a center section housing structural materials to provide structural strength to the top, wherein at least a part of the center section is proximate the front section; and
a side area defining one or more openings and proximate the center section, wherein the side area is recessed relative to the center section so that the center section is raised above the side area.

12. The method of claim 8, wherein altering the suspension system comprises adjusting the suspension system so that the overall height of the automobile is reduced in a range of approximately one inch to approximately three inches.

13. The method of claim 12, the suspension system comprising a stop bump, a shock, a leaf spring, and a coil spring, each having a length; and wherein altering the suspension system further comprises: decreasing the length of at least one of the stop bump, the shock, the leaf spring, and the coil spring.

14. The method of claim 8, the wheel system comprising a tire having a tire height, wherein altering the wheel system comprises reducing the tire height by approximately five percent.

15. An automobile lowering system to alter a factory-standard automobile having a height and an internal volume so that the height of the automobile falls below a predetermined threshold and the internal volume of the automobile is increased, the system comprising:
a top adapted to increase an interior height within the automobile in a range of about one inch to about eight inches thereby increasing the internal volume;
a suspension system adapted to lower the factory-standard automobile closer to a driving surface in a range of about one inch to about three inches;
a wheel system adapted to retrofit a first tire and wheel combination with a second tire and wheel combination that does not adversely affect operating instruments of the automobile; and
wherein the top, the suspension system, and the wheel system reduce the overall height of the automobile below the predetermined threshold.

16. The system of claim 15, wherein the predetermined threshold is approximately eighty-four inches so that the automobile can pass under structures having an entrance height of eighty-four inches.

17. The system of claim 15, wherein the top comprises:
a front section adapted to decrease drag friction associated with the top;
a center section housing strengthening materials to provide structural strength to the top, wherein at least a part of the center section is proximate the front section; and
a side area defining one or more openings and proximate the center section, wherein the side area is recessed relative to the center section so that the center section is raised above the side area.

18. The system of claim 15, wherein the suspension system alters the center of gravity of the automobile by lowering the center of gravity closer to the driving surface.

19. The system of claim 15, wherein the custom top comprises insulating and noise-dampening materials to insulate the interior of the automobile from exterior temperatures and exterior noises.

20. The system of claim 15, wherein the wheel system comprises a tire and wheel combination that is approximately five percent shorter in height than the factory standard tire and wheel.
